(19) United States
(12) Patent Application Publication
(10) Pub. No.: US 2016/0010566 A1
(43) Pub. Date: Jan. 14, 2016

(54) METHOD FOR OPERATING A GAS TURBINE BELOW ITS RATED POWER

(71) Applicant: SIEMENS AKTIENGESELLSCHAFT, München (DE)

(72) Inventors: Andreas Bottcher, Mettmann (DE); Eberhard Deuker, Mulheim an der Ruhr (DE); Andre Kluge, Dulmen (DE); Philipp Kreutzer, Haltern am See (DE); Marco Link, Mulheim (DE); Ansgar Sternemann, Herne (DE); Marc Tertilt, Hattingen (DE); Martin Wilke, Essen (DE)

(73) Assignee: Siemens Aktiengesellschaft, München (DE)

(21) Appl. No.: 14/768,827

(22) PCT Filed: Feb. 6, 2014
(86) PCT No.: PCT/EP2014/052310

§ 371 Date: Aug. 19, 2015

(30) Foreign Application Priority Data
Feb. 22, 2013 (DE) 10 2013 202 984.5

(51) Int. Cl. F02C 9/20; F02C 6/18; F01K 23/10; F02C 3/04

(52) U.S. Cl. CPC F02C 9/20; F02C 3/04; F02C 6/18; F01K 23/10; F05D 2220/32; F05D 2270/083

(57) ABSTRACT

A method for operating a gas turbine below its rated power, in which CO emissions in the exhaust gas of the gas turbine increase with a reduction of the output gas turbine power, wherein, if a predefined threshold value, which can be selected as desired, for the CO emissions is reached or if a predefined threshold value, specified in relative or absolute terms, for the output gas turbine power is undershot, the combustion temperature in the combustion chamber of the gas turbine is increased. To operate the gas turbine with low emissions, for a constant power output, the exhaust-gas temperature increase generated at the outlet of the gas turbine as a result of the combustion temperature increase is at least partially compensated through the addition of a liquid or vaporous medium.

### CROSS REFERENCE TO RELATED APPLICATIONS

This application is the US National Stage of International Application No. PCT/EP2014/052310 filed Feb. 6, 2014, and claims the benefit thereof. The International Application claims the benefit of German Application No. DE 102013202984.5 filed Feb. 22, 2013. All of the applications are incorporated by reference herein in their entirety.

### FIELD OF INVENTION

The invention relates to a method for operating a gas turbine below its rated power, in which CO emissions in the exhaust gas of the gas turbine increase with a reduction of the output gas turbine power, wherein, if a predefined threshold value for the CO emissions is reached or if a predefined threshold value for the output gas turbine power is undershot, the combustion temperature in the combustion chamber of the gas turbine is increased.

### BACKGROUND OF INVENTION

In the case of gas turbines used for generating electrical energy, it is known for these to be operated not only at rated load but also below rated load. This so-called part-load operation can however lead to a significant excess of air being encountered during the combustion of the fuel; the combustion air ratio is then significantly higher than 1. In the event of a reduction of load, it is usually the case that the compressor mass flow rate is reduced, whereby the pressure ratio of the compressor and thus also the combustion temperature of the fuel-air mixture in the combustion chamber decrease, which has an analogous effect on the primary zone temperature that is relevant for CO emissions. If said temperature then undershoots a minimum value, increased CO emissions are generated. In the case of a further reduced primary zone temperature, the CO emissions can increase to such an extent that they exceed a normally legally stipulated emissions threshold value, whereby the gas turbine is no longer operated in the part-load range that is compliant with regard to CO emissions. If a legal CO emissions threshold value is in force, this situation can force the operator of the gas turbine to shut its gas turbine down unless the power of its gas turbine can be further reduced and at the same time the CO emissions threshold value can be undershot.

To further increase the above-described part-load capability of the gas turbine, the document DE 10 2008 044 442 A1 which is known from the prior art proposes that such gas turbines be equipped with a bypass system through which a part of the compressor exit air can be conducted past the combustion chamber and fed into the exhaust-gas duct of the gas turbine. In this way, the air flow rate supplied for combustion can be reduced, which raises the combustion temperature and thus the relevant primary zone temperature. The increase then leads to a reduction in CO emissions, such that, despite further reduced load operation, the gas turbine can be operated in a compliant manner with regard to CO emissions. It is however a disadvantage that the mode of operation known from the prior art needlessly reduces the efficiency of the gas turbine because the compressed air that is conducted through the bypass does not contribute to the performance of work in the gas turbine.

### SUMMARY OF INVENTION

It is therefore an object of the invention to provide a method for operating a gas turbine which, despite part-load operation, exhibits relatively high efficiency in operation that is compliant with regard to CO emissions. It is a further object of the invention to provide a method in which the gas turbine operation that is compliant with regard to emissions is extended in the direction of lower loads.

The object directed to the method is achieved by means of the features of the independent claim. Advantageous refinements are specified in the subclaims, the technical teachings of which may be combined with one another as desired.

According to the invention, in the method for operating a gas turbine below its rated power, in which CO emissions in the exhaust gas of the gas turbine increase with a reduction of the output gas turbine power, wherein, if a predefined threshold value (which can be selected as desired) for the CO emissions is reached or if a predefined threshold value, specified in relative or absolute terms, for the output gas turbine power is undershot, the combustion temperature in the combustion chamber of the gas turbine is increased, it is provided that, for a constant power output, the exhaust-gas temperature increase generated at the outlet of the gas turbine as a result of the combustion temperature increase is at least partially compensated through the addition of a liquid or vaporous medium.

The increase of the exhaust-gas temperature provides an effective means for CO emissions reduction. Said measure has however hitherto been restricted by the maximum admissible operating temperature of the gas turbine components and of the components downstream of the gas turbine outlet. Examples of such components which restrict the temperature of the exhaust gas include a boiler, which operates as a heat recovery steam generator for a steam turbine positioned downstream of the gas turbine, an exhaust-gas housing of the gas turbine, and/or an exhaust-gas diffuser of the gas turbine. Since the exhaust-gas temperature is reduced by means of an addition of liquid or vaporous medium at or downstream of the outlet of the gas turbine, the exhaust-gas temperature prevailing upstream of the position at which said addition takes place may be significantly higher than the maximum admissible operating temperature of the exhaust-gas-conducting components situated downstream thereof. Consequently, the cycle that takes place in the gas turbine is performed with an exhaust-gas temperature that lies above the operating temperature of said components, wherein the components that restrict the exhaust-gas temperature nevertheless conduct an exhaust gas whose temperature lies below the maximum admissible operating temperature. Consequently, despite an elevated combustion temperature, it is ensured that the components downstream of the gas turbine outlet do not become too hot. This reduces the occurrence of CO emissions in part-load operation or makes it possible for the gas turbine to be operated in further lowered power ranges without risk to the components.

Within the context of this patent application, the combustion temperature is to be understood as being the temperature of the flames that are generated in the primary zone of burners. Said temperature is also known as theoretical flame temperature.

It must be ensured that, in the case of the invention, the vaporous or liquid medium is added not into the flame but rather into the exhaust gas generated by the flame. The former is conventional and was also used at a very early point in time to make it possible to control and reduce the NOₓ emissions of the hitherto conventional diffusion burners. The medium is advantageously added directly downstream of the final turbine stage of the gas turbine or downstream of the bearing star of the gas turbine in which the rotor of the gas turbine is normally radially mounted. These constructions for carrying out said method are relatively simple in relation to constructions that permit an addition of the medium directly downstream of the flame, for example upstream of the first or upstream of the second turbine stage. Nevertheless, the latter would have the advantage of the power and thus the efficiency being higher than in the case of an addition point arranged further downstream.

The predefined CO emissions threshold value beyond which the combustion temperature in the combustion chamber of the gas turbine is to be increased may have any desired value. Said threshold value is independent of the legally stipulated emissions threshold value for CO emissions. The predefined threshold value according to the invention for the CO emissions is selected such that it initiates the start of the method according to the invention in accordance with the desired mode of operation.

It is self-evidently also possible for parameters other than the CO emissions to be taken into consideration for the initiation of the method according to the invention. The other parameters may be used additionally or alternatively for the starting of the part-load operation with low CO emissions. For example, it is possible for the method according to the invention to be carried out only when a threshold value, specified in relative or absolute terms, of the gas turbine power is undershot. The output gas turbine power may be determined on the basis of thermodynamic data or also on the basis of the generator terminal power.

In a further refinement, the vaporous medium is process steam of a combined gas and steam turbine power plant, which in the case of very low load output must not release any process steam in order that said process steam is available for the cooling of the exhaust gas.

In one further refinement of the method, the combustion temperature is raised, and the added flow rate of medium selected, such that the exhaust-gas temperature that prevails after the addition of the medium is approximately equal to, or deviates only slightly from, the exhaust-gas temperature that would arise at the same location in the case of rated power without the addition of medium. This refinement is based on the following reasoning:

Normally, for a reduction of load proceeding from rated load, the intake mass flow rate of the compressor is initially reduced by virtue of inlet guide vanes of the compressor being rotated in a closing direction. With this measure, the pressure ratio of the gas turbine is reduced and, as a result, the exhaust-gas temperature increases in the case of a combustion temperature being kept constant. As already described further above, the maximum admissible exhaust-gas temperature at the turbine outlet is predefined by material temperatures of the gas turbine and also of any boiler (for steam generation) positioned downstream. If the exhaust gas reaches said maximum temperature in the case of a load reduction by means of compressor mass flow rate reduction, it is necessary in the case of the prior art, with a further reduction of the load, for the combustion temperature to also be further reduced. To prevent said reduction of the combustion temperature and thus keep the CO emissions at a relatively low value, it is particularly proposed that the compressor mass flow rate be further reduced, which would entail an increase of the exhaust-gas temperature to above the maximum admissible material temperature of the components positioned downstream of the gas turbine. To protect said components against overheating and thus against a shortening of service life, however, the inadmissibly elevated exhaust-gas temperature is reduced, through the addition of the vaporous or liquid medium, to such an extent that said exhaust-gas temperature is approximately equal to the maximum admissible material temperature of the gas turbine components or of the components positioned downstream of the gas turbine. Such gas turbines are normally designed such that the admissible material temperatures are achieved in rated-load operation.

A particular advantage of the invention is that existing gas turbines can be relatively easily converted for operation with the method according to the invention. No modifications to the gas turbine itself are required; it is rather merely necessary for the exhaust-gas path thereof to be equipped for the feeding-in of a liquid or vaporous medium. Also, there is no efficiency loss as encountered in the case of the prior art as a result of the bypassing of compressor exit air. It may even be the case that an efficiency improvement is achieved, because the burn-out of the flame is improved.

The invention will be explained in more detail on the basis of a single exemplary embodiment, wherein this is however not intended to constitute a further restriction of the invention.

### BRIEF DESCRIPTION OF THE DRAWINGS

In this regard, the single FIGURE schematically shows a gas turbine with a facility for supplying a vaporous or liquid medium into the exhaust gas.

### DETAILED DESCRIPTION OF INVENTION

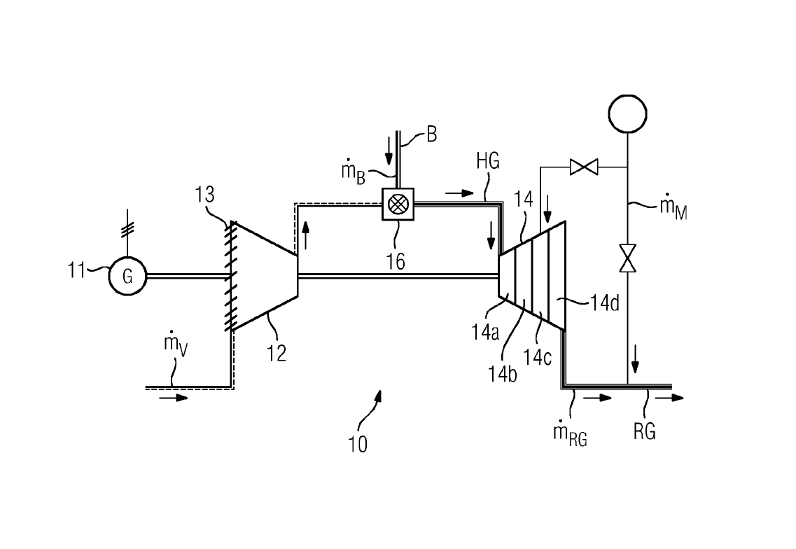

FIG. 1 schematically shows a static gas turbine 10 with a compressor 12 and a turbine unit 14, the rotors of which are rigidly coupled to one another. A combustion chamber 16 is provided between the compressor outlet and the inlet section of the turbine unit 14. Said combustion chamber may be in the form of a silo combustion chamber, tubular combustion chamber or else an annular combustion chamber. In the case of tubular combustion chambers, the gas turbine 10 has at least ten, twelve or more tubular combustion chambers.

Furthermore, a generator 11 for electricity generation is coupled to the compressor rotor.

At the air inlet of the compressor 12 there are provided compressor inlet guide vanes 13 which are pivotable about their longitudinal axes and by means of which the compressor mass flow rate mᵥ can be adjusted. Said guide vanes 13 are merely schematically illustrated. In the exemplary embodiment, the turbine unit 14 comprises a total of four successive turbine stages 14ₐ, 14_{b}, 14_{c}, 14_{d}, which in the single figure are likewise only schematically illustrated.

During operation, the compressor 12 draws in ambient air, compresses the latter and conducts it to the combustion chamber 16. There, the compressed air is mixed with a fuel B and is burned in a flame to form a hot gas HG. The hot gas HG flows into the inlet of the turbine unit 14 and expands at the turbine blades (not illustrated in any more detail) of the turbine unit 14, performing work. The exhaust gas RG thus generated flows out at the outlet of the turbine unit 14 via an exhaust-gas diffuser (not illustrated). The exhaust gas RG is thereafter either discharged into the environment via a chimney, or the exhaust gas RG is supplied to a so-called boiler which, as a heat recovery steam generator, utilizes the heat energy contained in the exhaust gas for the generation of steam. The steam generated in the heat recovery steam generator then serves for driving steam turbines (not illustrated in any more detail) or else as process steam.

The power to be output by the gas turbine 10 can be adjusted by means of the fuel mass flow rate m_{B} and the compressor mass flow rate m_{V}.

If the gas turbine 10 is operated below its rated power and thus provides only a fraction of its maximum possible power output to the generator 11 at the compressor shaft, it is provided that, to reduce CO emissions, the combustion temperature or primary zone temperature that prevails in the combustion chamber 16 is increased by virtue of the compressor inlet guide vanes 13 being rotated further in a closing direction while the fuel mass flow rate m_{B} is kept constant. Since the gas turbine 10 is already in part-load operation and the temperature of the hot gas HG at the turbine inlet is already below the maximum admissible turbine inlet temperature, the combustion temperature can be increased further without the components arranged at the turbine inlet being subjected to an inadmissibly high material temperature, which would shorten the service life thereof. Since the exhaust-gas temperature may however at the same time become inadmissibly high owing to the increased combustion temperature, it is provided that, either downstream of the penultimate turbine stage 14c of the gas turbine 10 and/or downstream of the final turbine stage 14d of the gas turbine 10, a vaporous or liquid medium M is supplied which at least partially compensates the exhaust-gas temperature increase that arises in the exhaust gas RG as a result of the combustion temperature increase.

1.-6. (canceled)

7. A method for operating a gas turbine below its rated power,
wherein CO emissions in the exhaust gas of the gas turbine increase with a reduction of the output gas turbine power, the method comprising:
if a predefined threshold value for the CO emissions is reached or if a predefined threshold value for the output gas turbine power is undershot, increasing the combustion temperature in the combustion chamber of the gas turbine,
wherein the exhaust-gas temperature increase generated at the exhaust-gas outlet of the gas turbine as a result of the combustion temperature increase is at least partially compensated through the addition of a medium which is liquid or vaporous, and
supplying the medium to the exhaust gas downstream of the final turbine stage of the gas turbine.

8. The method as claimed in claim 7,
wherein, without a change in load, the combustion temperature is raised, and the added flow rate of medium selected, such that the exhaust-gas temperature that prevails after the addition of the medium is approximately equal to or slightly higher than the exhaust-gas temperature that arises at the same location in the case of rated power.

9. The method as claimed in claim 7,
wherein, for the increase of the combustion temperature, the flow rate of a fuel supplied to the combustion chamber is increased, and/or the flow rate of combustion air supplied to the combustion chamber is reduced by virtue of inlet guide vanes of a compressor of the gas turbine being rotated further in a closing direction.

10. The method as claimed in claim 7, further comprising:
extracting the medium from the process steam of a steam turbine power plant positioned downstream of the gas turbine.
